(19) United States
(12) Patent Application Publication
(10) Pub. No.: US 2015/0177460 A1
(43) Pub. Date: Jun. 25, 2015

(54) OPTICAL FIBER CLEAVING MECHANISM AND METHOD OF USE

(71) Applicant: TYCO ELECTRONICS RAYCHEM BVBA, Kessel-Lo (BE)

(72) Inventors: Petrus Theodorus Krechting, AJ Enschede (NL); Petrus Theodorus Rutgers, BW Hengelo (NL); Karel Johannes Van Assenbergh, Twist (DE); Cristian-Radu Radulescu, Leige (BE); Jan Watte, Grimbergeren (BE)

(21) Appl. No.: 14/414,011

(22) PCT Filed: Jul. 12, 2013
(86) PCT No.: PCT/EP2013/064766

§ 371 Date: Jan. 9, 2015

Related U.S. Application Data
(60) Provisional application No. 61/670,855, filed on Jul. 12, 2012.

(51) Int. Cl. G02B 6/25

(52) U.S. Cl. CPC G02B 6/25

(57) ABSTRACT

A cleaving mechanism and related method is adapted to cleave an optical fiber and thereby produce a cleaved end on the optical fiber. The cleaving mechanism includes a fixture, a cleave tool for cleaving the optical fiber, a clamp, a scoring member, and a tensioner. The fixture and clamp may hold the optical fiber without substantial twisting of the optical fiber. The fixture and/or the clamp may include a set of flexures that may include a pair of bending beam elements. The tensioner may include a voice coil and may detect slippage of the optical fiber. The tensioner may tune tension on the optical fiber and thereby tune a cleaving angle of the cleaved end. The cleaving mechanism may further include a vision system and thereby further tune the tension. The tensioner may compensate for wear of the cleaving mechanism. The cleave tool may include a bending anvil. The optical fiber may be included in a fiber optic cable that may further include a protective layer surrounding the optical fiber.

### TECHNICAL FIELD

The present disclosure relates to preparing optical fibers for joining to other optical fibers. In particular, the disclosure is related to preparing ends of optical fibers by cleaving.

### BACKGROUND

Present day telecommunications technology utilizes, to an increasing extent, optical fibers for signal transmission. When preparing fiber optic networks, it is often necessary to join optical fibers together. The joining of the optical fibers can be accomplished by splicing or by connectorization.

To connect optical fibers, mechanical splicing can be used. Fiber ends of the optical fibers may be aligned and held together by a precision-made sleeve, often using a clear index matching material, such as an index matching gel, that enhances the transmission of light across the splice (i.e., the joint). Mechanical splicing may also be intended for a permanent connection, although in certain cases the fibers can still be disconnected and connected again afterwards. An example of a mechanical splicing system is the RECORDsplice™ from Tyco Electronics. Before making a mechanical splice, the fibers are stripped of their coating, so that bare fiber ends are obtained. To obtain well-defined end faces that can subsequently be abutted in the mechanical splice, the ends are mechanically cleaved with a precision cleave tool, such as the one used in the RECORDsplice Cleaver and Assembly Tool (RCAT).

If the fibers need to be connected, disconnected, reconnected, and/or “mated” several times, connectors may be used. An optical fiber connector is basically a rigid cylindrical barrel surrounded by a sleeve that holds the barrel in its mating socket. The mating mechanism can, for example, be “push and click”, “turn and latch”, etc. Good alignment of the connected optical fibers is extremely important in order to obtain a good quality connection with low optical signal losses. Usually, so called ferruled connectors are used, wherein the stripped fiber is positioned coaxially in a ferrule. Ferrules can be made of ceramic, metal, or sometimes plastic and have a drilled center hole. Ferruled connectors are expensive, however. The center hole has to be drilled very accurately for good alignment of the optical fiber. Further, the fiber's end face is polished, so that the fibers in the two ferruled connectors make good physical contact. The polishing step is expensive. Alternative alignment solutions, containing ferrule-less connectors, are much less expensive.

In ferrule-less arrangements, after both stripped fibers are cleaved mechanically, an optical end to end contact between both fibers may be established, possibly using index matching gel. The cleaved fibers may be inserted, without ferrules, into an alignment structure for alignment with each other, thus creating an optical transmission path. The alignment structure may, for example, include a V-groove. It has been observed that when ferrule-less, mechanically cleaved fibers are repeatedly connected and disconnected in an alignment structure, the connection and disconnection operation cannot be performed frequently before the quality of the optical connection decreases significantly.

An alternative for mechanical cleaving is laser cutting. U.S. Pat. No. 6,963,687 discloses a process for cutting an optical fiber by means of a laser. Very good results are achieved using a CO₂ laser (wavelength 10.6 μm) having a pulse length of 35 μs and a peak power of 600 watts. The laser cuts the fiber and polishes the end face of the fiber simultaneously. The laser-cut end face tends to have rounded edges rather than sharp edges; these rounded edges are better suited for alignment in a V-groove, since rounded edges glide along the V-groove whereas the sharp edges might potentially create debris in the optical path by their contact with the V-groove.

U.S. Pat. No. 6,331,081 discloses a connector and a method for making the connector, wherein one or more optical fibers are attached to the main body of the connector. One end face of each optical fiber is exposed and used as a connecting end face to another connector. The coating of each optical fiber is removed, so that the core (i.e., the central, light-transmitting region of the fiber and the cladding) is exposed. The end face of the thus exposed optical fiber is processed by spark discharging such that at least the front end of a core portion projects from the front end of a cladding portion. The thus processed optical fiber is then inserted into the main body of the connector and attached to it so that the end face projects from the connecting end face of the main body by a predetermined amount. In this way, a connection at a high accuracy can be established, particularly when using an optical fiber ribbon including a plurality of optical fibers and while establishing so-called physical contact (PC) to the optical fibers of the other connector by buckling the optical fibers.

JP 7-306333 describes a method for rounding edges of an end face of an optical fiber by heat treatment, chemical processing with an acid or the like, or physical processing with abrasive grains.

JP 55-138706 discloses a method in which the end face of an optical fiber is heated by an electric arc discharge so as to yield a rounded end face with a radius not smaller than the radius of the optical fiber.

Before splicing or connectorization of the optical fibers is performed, ends of the optical fibers are typically prepared. Various machines and devices have been disclosed that are designed to prepare the ends of the optical fibers. European Patent EP 1 853 953 and related U.S. Pat. No. 7,805,045, which are incorporated herein by reference in their entireties, give examples of such devices.

The overall quality of the joint joining two of the optical fibers together may be influenced by the quality of the preparation of the ends of the optical fibers.

A need still exists for an affordable and high quality method for mechanically connecting optical fibers.

### SUMMARY

An aspect of the present disclosure relates to a cleaving mechanism for cleaving an optical fiber. Cleaving the optical fiber produces a cleaved end on the optical fiber. The cleaving mechanism may include a fixture, a cleave tool, a clamp, and a tensioner. The fixture holds the optical fiber. The cleave tool is adapted to cleave the optical fiber. The clamp is adapted to clamp the optical fiber without substantial twisting of the optical fiber. Any twisting of the optical fiber by the clamp may be limited to a predetermined limit. In certain embodiments, the predetermined limit may be less than about 200 degrees per meter of optical fiber length. The clamp may be positioned opposite the fixture about the cleave tool. The clamp may include a set of flexures. The set of flexures may be stiff in a first translational direction, a second translational direction, and all rotational directions and may be limber in a translational clamping direction. The set of flexures may include a pair of bending beam elements. The tensioner is adapted to apply tension on the optical fiber when the optical fiber is held by the fixture and is clamped by the clamp. The tensioner may apply a force F on the clamp and thereby may apply the tension on the optical fiber when the optical fiber is held by the fixture and is clamped by the clamp. The tensioner may include a voice coil. The tensioner may be adapted to detect slippage of the optical fiber with respect to the clamp. The cleaving mechanism may stop the cleave tool from cleaving the optical fiber when the tensioner detects the slippage of the optical fiber with respect to the clamp. The tensioner may be adapted to tune an amount of the tension and thereby tune a cleaving angle of the cleaved end. The cleaving mechanism may further include a vision system adapted to provide feedback and thereby further tune the amount of the tension. The tensioner may be adapted to compensate for wear of the cleaving mechanism. In certain embodiments, the optical fiber may be cleaved generally perpendicular to a longitudinal axis of the optical fiber. In other embodiments, the optical fiber may be cleaved about 8 degrees from perpendicular to a longitudinal axis of the optical fiber. The cleaving mechanism may further include a scoring member adapted to score the optical fiber before the cleaving tool cleaves the optical fiber. The cleave tool may include a bending anvil. The bending anvil may include a double anvil structure. The fixture may include a fixture clamp adapted to clamp and thereby hold the optical fiber. The optical fiber may be included in a fiber optic cable, and the fiber optic cable may further include a protective layer that surrounds the optical fiber. The fixture may be adapted to hold the optical fiber by holding the protective layer that surrounds the optical fiber.

Other aspects of the present disclosure may include a method for cleaving an optical fiber. The method may include providing the optical fiber, holding the optical fiber at a first location of the optical fiber, clamping the optical fiber at a second location of the optical fiber, tensioning the optical fiber between the first and the second locations of the optical fiber, and cleaving the optical fiber between the first and the second locations of the optical fiber. A fixture may hold the optical fiber at the first location. A clamp may clamp the optical fiber at the second location without substantial twisting of the optical fiber between the first and the second locations. Any twisting of the optical fiber by the clamp may be limited to a predetermined limit. In certain embodiments, the predetermined limit may be less than about 200 degrees per meter of optical fiber length. A tensioner may tension the optical fiber between the first and the second locations of the optical fiber. A cleave tool may cleave the optical fiber between the first and the second locations of the optical fiber. A cleaving mechanism may include the fixture, the clamp, the tensioner, and the cleave tool. The method may further include detecting potential slippage of the optical fiber. The method may further include postponing the cleaving of the optical fiber if any slippage is detected. The method may further include re-clamping and/or re-holding the optical fiber if any slippage is detected and resuming the cleaving of the optical fiber if no slippage is detected upon the re-clamping and/or the re-holding the optical fiber. The method may further include tuning an amount of the tensioning and thereby tuning a cleaving angle of a cleaved end of the optical fiber. The method may further include providing feedback with a vision system and thereby further tuning the amount of the tensioning. The method may further include compensating for wear of the cleaving mechanism by adjusting an amount of the tensioning. The method may further include scoring the optical fiber between the first and the second locations of the optical fiber before the cleaving of the optical fiber.

Still other aspects of the present disclosure may include a method for cleaving an optical fiber. The method may include providing the optical fiber, holding the optical fiber with a fixture at a first location of the optical fiber, clamping the optical fiber with a clamp at a second location of the optical fiber, applying a tensile force on the optical fiber between the first and the second locations of the optical fiber with an electromagnetic coil, and cleaving the tensioned optical fiber between the first and the second locations of the optical fiber with a cleave tool. The electromagnetic coil may be a voice coil. The method may further include measuring the tensile force applied on the optical fiber by the electromagnetic coil. The method may further include detecting slippage of the optical fiber at the first location relative to the fixture and/or at the second location relative to the clamp by monitoring the measuring of the tensile force. The method may further include suspending the cleaving of the optical fiber when the slippage is detected, reclamping and/or reholding the optical fiber, and resuming the cleaving of the optical fiber if no slippage is detected. The method may further include adjusting the tensile force applied on the optical fiber by the electromagnetic coil to a desired tension value. The method may further include measuring an angle α of an end face of the optical fiber after cleaving. The angle of the end face of the optical fiber after cleaving may be measured with a camera. The method may further include correlating the measured angle and the measured tensile force and determining the desired tension value based on the correlating of the measured angle and the measured tensile force. The method may further include statistical processing of the correlating of the measured angle and the measured tensile force and subsequently determining the desired tension value based on the correlating of the measured angle and the measured tensile force as refined by the statistical processing. The clamping of the optical fiber may be done without substantial twisting of the optical fiber. The clamp may include a set of flexures.

Yet other aspects of the present disclosure may include a cleaving mechanism for cleaving an optical fiber and thereby producing a cleaved end on the optical fiber. The cleaving mechanism may include a fixture, a cleave tool, a clamp, and an electromagnetic coil. The fixture may hold the optical fiber. The cleave tool may be adapted to cleave the optical fiber. The clamp may be adapted to clamp the optical fiber. The clamp may be positioned opposite the fixture about the cleave tool. The electromagnetic coil may be adapted to apply tension to the optical fiber between the fixture and the clamp. The electromagnetic coil may be a voice coil. The electromagnetic coil may be adapted to tune an amount of the tension and thereby tune a cleaving angle α of the cleaved end. The cleaving mechanism may further include a vision system that is adapted to provide feedback and thereby tune the amount of the tension. The clamp may include a set of flexures. The set of flexures may be stiff in a first translational direction, a second translational direction, and/or all rotational directions and may be limber in a translational clamping direction. The set of flexures may include a pair of bending beam elements.

Still other aspects of the present disclosure may include a method for cleaving an optical fiber. The method may include providing the optical fiber, holding the optical fiber with a fixture at a first location of the optical fiber, clamping the optical fiber with a clamp at a second location of the optical fiber, cleaving the optical fiber between the first and the second locations of the optical fiber with a cleave tool, and measuring an angle α of an end face of the optical fiber after cleaving. The angle of the end face of the optical fiber after cleaving may be measured with a camera. The method may further include correlating the measured angle and a measured parameter of the clamp, the fixture, and/or the cleave tool and determining the measured parameter based on the correlating of the measured angle and the measured parameter. The method may further include statistical processing of the correlating of the measured angle and the measured parameter and subsequently determining the desired measured parameter based on the correlating of the measured angle and the measured parameter as refined by the statistical processing.

Yet other aspects of the present disclosure may include a cleaving mechanism for cleaving an optical fiber and thereby producing a cleaved end on the optical fiber. The cleaving mechanism may include a fixture, a cleave tool, a clamp, and a camera. The fixture may hold the optical fiber. The cleave tool may be adapted to cleave the optical fiber. The clamp may be adapted to clamp the optical fiber. The clamp may be positioned opposite the fixture about the cleave tool. The camera may be adapted to measure an angle α of an end face of the optical fiber after cleaving.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a schematic illustration of a fiber optic cleaving mechanism according to the principles of the present disclosure;

FIG. 2 is a partial perspective view of a cleaving tool of the fiber optic cleaving mechanism of FIG. 1;

FIG. 3 is a schematic illustration of a fiber clamp of the fiber optic cleaving mechanism of FIG. 1;

FIG. 4 is a schematic illustration of a prior art clamp for clamping optical fibers, the prior art clamp shown in a closed position before a clamping force is developed;

FIG. 5 is the schematic illustration of FIG. 4, but shown after the clamping force is developed;

FIG. 6 is a surface measurement of a cleaved end of an optical fiber cleaved by the fiber optic cleaving mechanism of FIG. 1;

FIG. 7 is a surface measurement of a cleaved end of an optical fiber cleaved by a prior art fiber optic cleaving mechanism that includes the prior art clamp of FIGS. 4 and 5;

FIG. 8 is a distribution of cleaving angle measurements of a set of cleaved ends of optical fibers cleaved by the fiber optic cleaving mechanism of FIG. 1;

FIG. 9 is a distribution of cleaving angle measurements of a set of cleaved ends of optical fibers cleaved by the prior art fiber optic cleaving mechanism of FIG. 7;

FIG. 10 is another surface measurement of a cleaved end of an optical fiber cleaved by the fiber optic cleaving mechanism of FIG. 1;

FIG. 11 is still another surface measurement of a cleaved end of an optical fiber cleaved by the fiber optic cleaving mechanism of FIG. 1;

FIG. 12 is still another surface measurement of a cleaved end of an optical fiber cleaved by the fiber optic cleaving mechanism of FIG. 1;

FIG. 13 is still another surface measurement of a cleaved end of an optical fiber cleaved by the fiber optic cleaving mechanism of FIG. 1;

FIG. 14 is another surface measurement of a cleaved end of an optical fiber cleaved by a prior art fiber optic cleaving mechanism that includes the prior art clamp of FIGS. 4 and 5;

FIG. 15 is still another surface measurement of a cleaved end of an optical fiber cleaved by a prior art fiber optic cleaving mechanism that includes the prior art clamp of FIGS. 4 and 5;

FIG. 16 is still another surface measurement of a cleaved end of an optical fiber cleaved by a prior art fiber optic cleaving mechanism that includes the prior art clamp of FIGS. 4 and 5;

FIG. 17 is still another surface measurement of a cleaved end of an optical fiber cleaved by a prior art fiber optic cleaving mechanism that includes the prior art clamp of FIGS. 4 and 5;

FIG. 18 is an elevation view of jaw portions of a cleaving tool of the fiber optic cleaving mechanism of FIG. 1;

FIG. 19 is an enlarged version of FIG. 18; and

FIG. 20 is an elevation view of jaw portions of a cleaving tool of the fiber optic cleaving mechanism of FIG. 1.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

According to the principles of the present disclosure, an optical fiber cleaving mechanism includes a clamping system that substantially eliminates axial twisting of an optical fiber that is cleaved by the optical fiber cleaving mechanism. By substantially eliminating the axial twisting of the optical fiber when clamping, an improved cleaved end is formed on the optical fiber when the optical fiber is cleaved in comparison to cleaved ends formed on optical fibers by prior art optical fiber cleaving mechanisms that include prior art clamping systems. An improved optical joint may result when using one or two of the improved cleaved ends formed on one or two of the optical fibers of the optical joint. Any twisting of the optical fiber by the clamp may be limited to a predetermined limit. In certain embodiments, the predetermined limit may be less than about 200 degrees per meter of optical fiber length. In other embodiments, the predetermined limit may be less than about 100 degrees per meter of optical fiber length. In still other embodiments, the predetermined limit may be less than about 50 degrees per meter of optical fiber length.

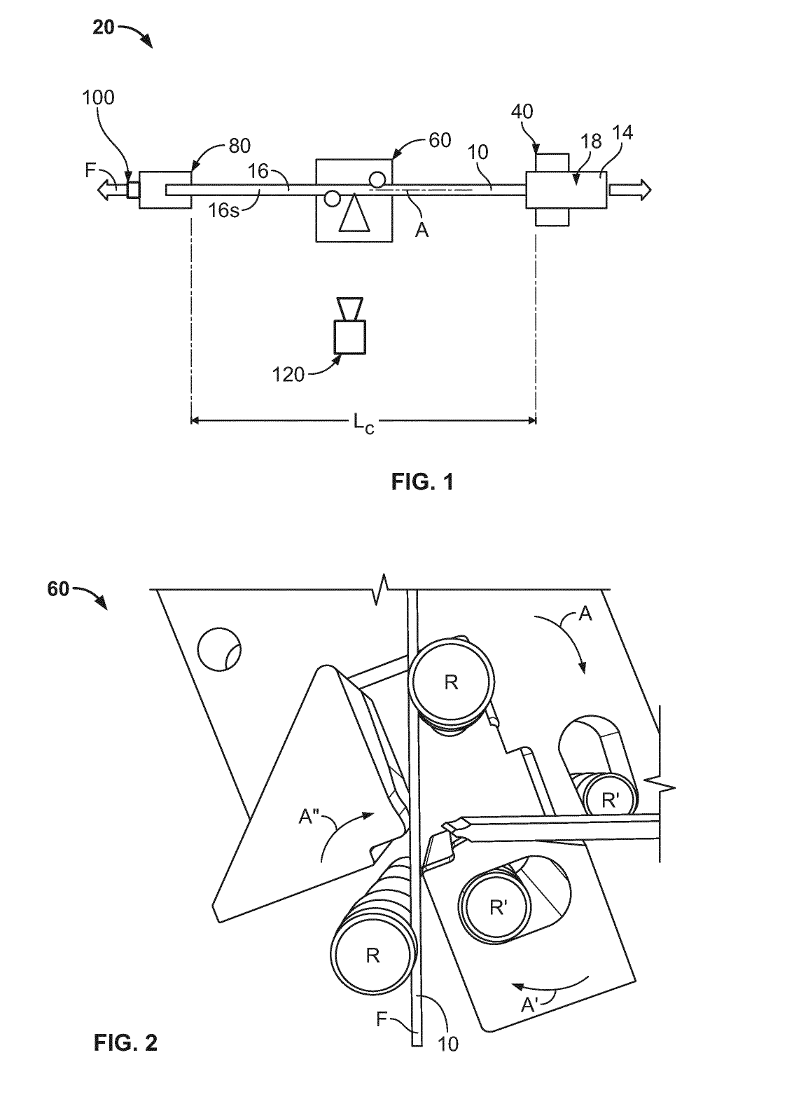

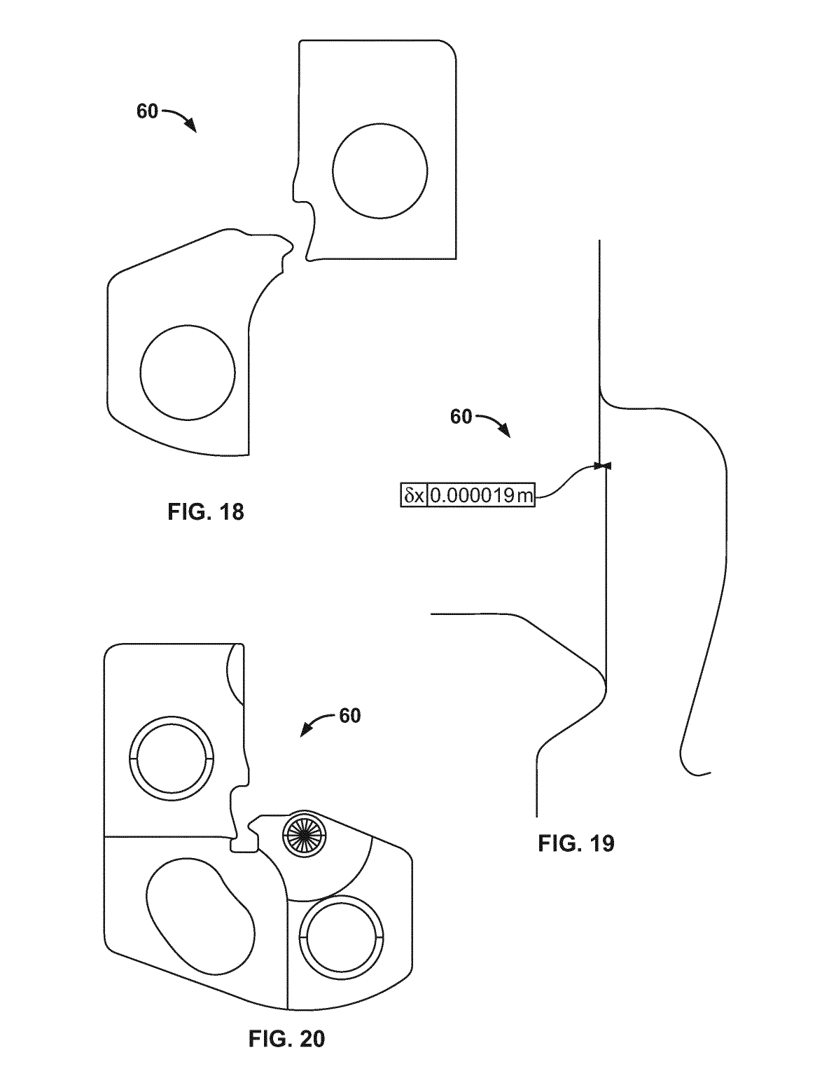

According to the principles of the present disclosure, an example cleaving mechanism 20 includes a fixture 40, a cleave tool 60, a clamp 80, and a tensioner 100 (see FIGS. 1, 2, and 18-20). In certain embodiments, the cleaving mechanism 20 may include a vision system 120. Methods of using the cleaving mechanism 20 generally follow the disclosure given at EP 1 853 953 and related U.S. Pat. No. 7,805,045, which were incorporated by reference above. The features and methods disclosed herein are generally adaptable to cleaving mechanisms and related methods disclosed at EP 1 853 953 and U.S. Pat. No. 7,805,045. In addition to the features and methods disclosed herein, refer to EP 1 853 953 and U.S. Pat. No. 7,805,045 for details and background on cleaving and splicing optical fibers.

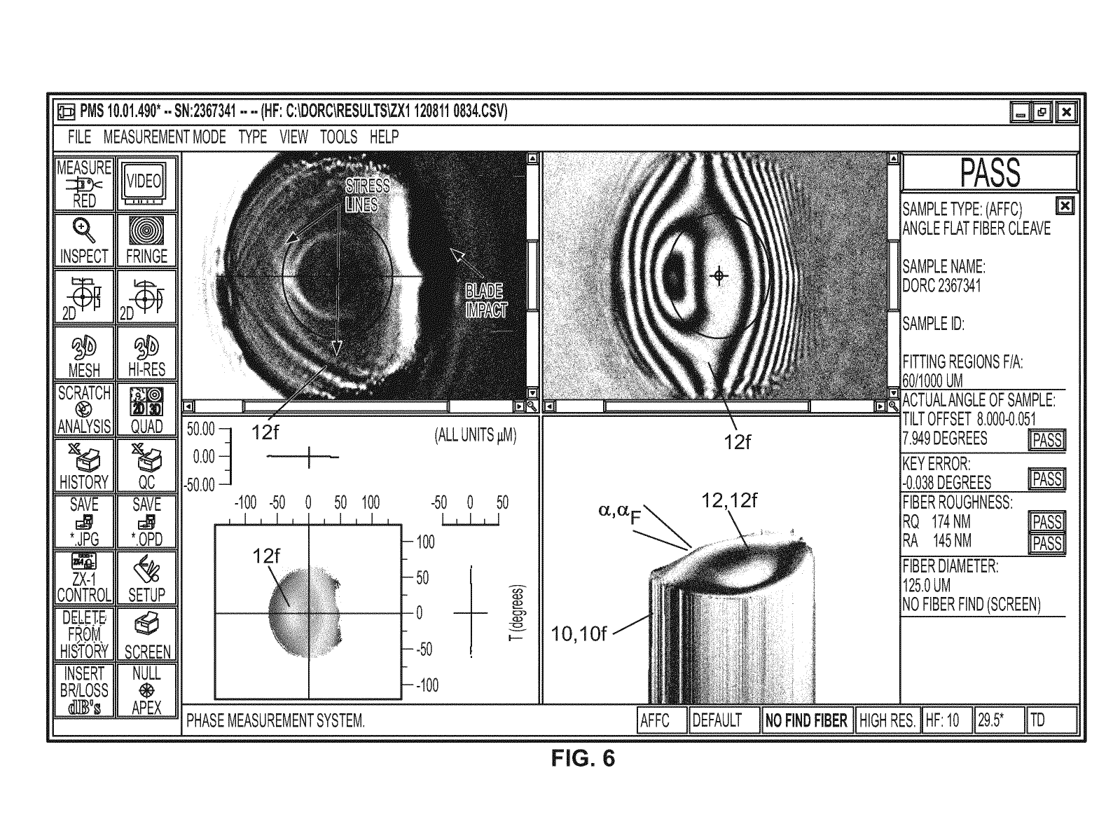

A method of cleaving an optical fiber 10, and thereby forming a cleaved end 12 on the optical fiber 10, may include stripping a protective coating 14 off of an end portion 16 of a fiber optic cable 18, thereby forming a stripped end portion 16s (see FIGS. 1 and 6). The stripped end portion 16s may be placed in the cleaving mechanism 20. In particular, the stripped end portion 16s may be placed within the cleave tool 60 and the clamp 80. In certain embodiments, the stripped end portion 16s may also be placed within the fixture 40. In other embodiments, including the embodiment illustrated at FIG. 1, the fiber optic cable 18, including the protective coating 14, may be placed within the fixture 40. Upon placing the fiber optic cable 18 and/or the optical fiber 10 within the cleaving mechanism 20, the fiber optic cable 18 and/or the optical fiber 10 may be clamped or otherwise secured to the fixture 40. Upon the fiber optic cable 18 and/or the optical fiber 10 being secured to the fixture 40, the clamp 80 may be actuated and thereby secured to the stripped end portion 16s of the optical fiber 10. Upon the stripped end portion 16s of the fiber optic cable 18 being secured by the clamp 80, the tensioner 100 may apply tension to the fiber optic cable 18 and/or the optical fiber 10 between the fixture 40 and the clamp 80. Upon tension being applied to the fiber optic cable 18 and/or the optical fiber 10, the cleave tool 60 may be actuated and thereby cleave the optical fiber 10 thereby producing the cleaved end 12.

In certain embodiments, the cleaved end 12 may be formed generally perpendicular to an axis A of the optical fiber 10. In certain embodiments, the cleaved end 12 may be formed at a cleaving angle α from perpendicular to the axis A. In embodiments with the cleaved end 12 formed at the cleaving angle α, the cleaved end 12 may be abutted with another cleaved end 12 to form a mechanical splice joint. In certain embodiments, the mechanical splice joint may be finished without polishing of the cleaved ends 12. In certain embodiments, the mechanical splice joint may be finished without fusing (i.e., melting together) the cleaved ends 12.

As illustrated at FIG. 1, the fixture 40 may be spaced from the clamp 80 by a distance L_{C}. In certain embodiments, the distance L_{C} may range from about 40 millimeters to about 50 millimeters. The selection of the distance L_{C}, in part, determines the degree of twisting of the optical fiber 10 per unit length. For example, with the distance L_{C} set to 50 millimeters and a twist angle β of the optical fiber 10 between the fixture 40 and the clamp 80 of 10 degrees, the amount of twist per unit length of the optical fiber 10 may be 3/L_{C}=10 degrees/0.05 meter=200 degrees per meter of optical fiber length. The degree of twisting of the optical fiber 10 per unit length is thus reduced by increasing the distance L_{C} and/or by reducing the twist angle β of the optical fiber 10 between the fixture 40 and the clamp 80. In certain embodiments, the cleave tool 60 may depend upon the fixture 40 and/or the clamp 80 to support the optical fiber 10 for proper operation. Thus, the distance L_{C} cannot be arbitrarily increased, in certain embodiments. Furthermore, increasing the distance L_{C} may increase an overall size of the cleaving mechanism 20. In certain embodiments and especially in portable embodiments, an increase in the overall size of the cleaving mechanism 20 is undesired. As will be explained in detail below, reducing the twist angle β of the optical fiber 10 between the fixture 40 and the clamp 80 may be achieved by the improved clamp 80, according to the principles of the present disclosure.

As mentioned in the references EP 1 853 953 and U.S. Pat. No. 7,805,045, other operations and/or components may be included in the cleaving of the optical fiber 10. For example, the optical fiber 10 may be scored by a scoring member before the cleave tool 60 is actuated. In certain embodiments, the scoring member includes a diamond blade. The scoring member may depend upon the fixture 40 and/or the clamp 80 to support the optical fiber 10 for proper operation. Thus, the distance L_{C} cannot be arbitrarily increased, in certain embodiments.

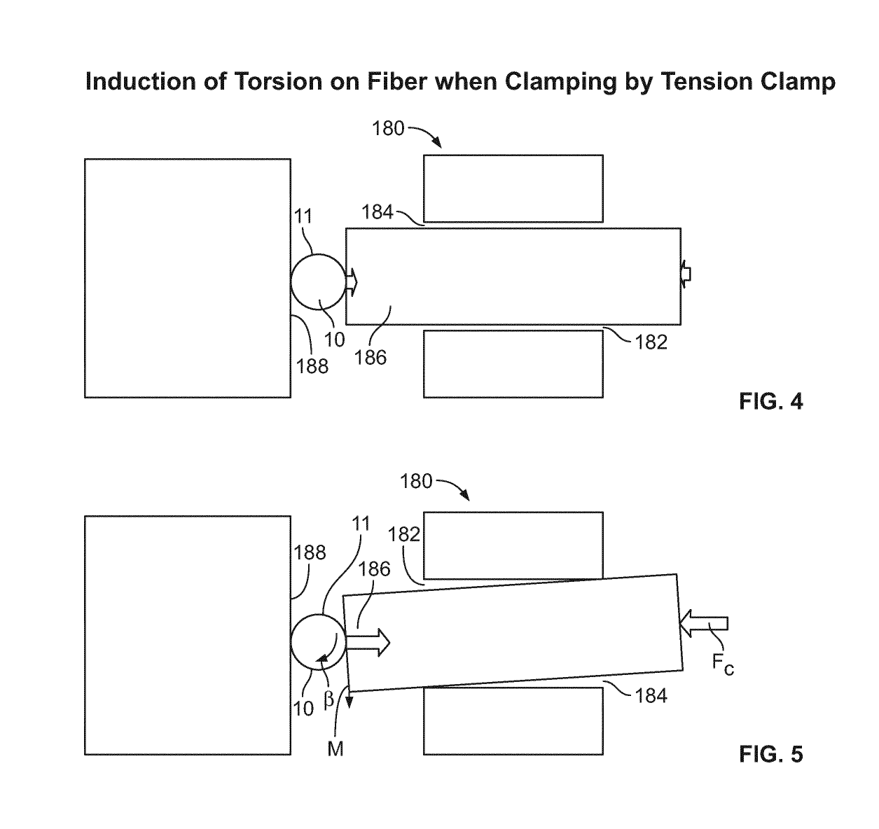

Turning now to FIGS. 4 and 5, a schematic representation of a prior art clamping mechanism 180 is illustrated. The prior art clamping mechanism 180 includes a joint 182 with a clearance 184. In certain prior art clamping mechanisms 180, the joint 182 may be a translating joint. In other prior art clamping mechanisms 180, the joint 182 may be a rotational joint. As the joint 182 includes the clearance 184, a clamping portion 186 of the prior art clamping mechanism 180 may undergo movement M as loading across the joint 182 shifts the clearance 184. As the stripped end portion 16s of the optical fiber 10 is very small in diameter (e.g., 125 μm), even a very small movement of the clamping portion 186 may result in a rotation of a portion of the optical fiber 10 that is clamped by the prior art clamping mechanism 180.

As illustrated at FIG. 5, the rotation of the portion of the optical fiber 10 that is clamped by the prior art clamping mechanism 180 results in the twist angle β. The prior art clamping mechanism 180 may impart substantial axial twisting of the optical fiber 10 when it is being clamped by the prior art clamping mechanism 180. For example, if the movement M results in a displacement of 0.1 millimeter tangent to the 125 μm diameter optical fiber 10, the twist angle β can be calculated as follows. A circumference of the 125 μm diameter optical fiber 10 is 0.125 mm×π=0.3927 millimeter. The tangential displacement of 0.1 millimeter is thus 0.1/0.3927=25.46% of the circumference. Thus, the twist angle β is 25.46%×360 degrees=91.67 degrees. With the distance L_{C} set to 50 millimeters and the twist angle β of the optical fiber 10 between the fixture 40 and the clamp 180 of 91.67 degrees, the amount of twist per unit length of the optical fiber 10 may be β/L_{C}=91.67 degrees/0.05 meter=1,833 degrees per meter of optical fiber length.

As depicted at FIGS. 4 and 5, the clearance 184 results in a looseness of the clamping portion 186 with respect to a clamping surface 188 of the prior art clamping mechanism 180. As the optical fiber 10 is cylindrically shaped, it provides a rolling surface 11 that accommodates the movement M. Upon a clamping force F_{C} being generated between the clamping portion 186 and the clamping surface 188, instability may occur due, at least in part, to the clearance 184, the compressive clamping force F_{C}, and the rolling surface 11. As illustrated at FIG. 5, equilibrium of the clearance 184, the compressive clamping force F_{C}, and the rolling surface 11 may be achieved by the movement M which causes portions of the clearance 184 to close, the clamping portion 186 to shift, the rolling surface 11 to roll, and thereby the twist angle β to occur. Therefore, when the rolling surface 11 of the optical fiber 10 rolls, twisting of the optical fiber 10 is induced by the clamping portion 186 and the clamping surface 188.

A magnitude of the twist angle β may be reduced by decreasing the clearance 184 and thereby the looseness of the clamping portion 186 with respect to the clamping surface 188 of the prior art clamping mechanism 180. However, reducing the clearance 184 to zero may cause high friction and/or other undesirable effects that interfere with the prior art clamping mechanism 180.

The axial twisting of the optical fiber 10 results in torsional stresses being developed along the optical fiber 10, the optical fiber 10 being rotationally out of a nominal position, and the optical fiber 10 being translationally out of the nominal position. When the torsional stresses are present and the optical fiber 10 is cleaved, the cleaved end 12 of the optical fiber 10 may include defects, imperfections, etc. that are caused by the torsional stresses. In addition, as the torsional stresses may vary from a first cleaving operation to a second cleaving operation, the cleaved end 12 of the optical fiber 10 may include variations that are caused by the torsional stresses. When the optical fiber 10 is rotationally out of position and the optical fiber 10 is cleaved, the cleaved end 12 of the optical fiber 10 may include defects, imperfections, etc. that are caused by the optical fiber 10 being rotationally out of position. In addition, as the optical fiber 10 may be rotationally out of position at various positions from the various cleaving operations, the cleaved end 12 of the optical fiber 10 may include variations that are caused by the variability of the rotational position of the optical fiber 10. When the optical fiber 10 is translationally out of position and the optical fiber 10 is cleaved, the cleaved end 12 of the optical fiber 10 may include defects, imperfections, etc. that are caused by the optical fiber 10 being translationally out of position. In addition, as the optical fiber 10 may be translationally out of position at various positions from the various cleaving operations, the cleaved end 12 of the optical fiber 10 may include variations that are caused by the variability of the translational position of the optical fiber 10.

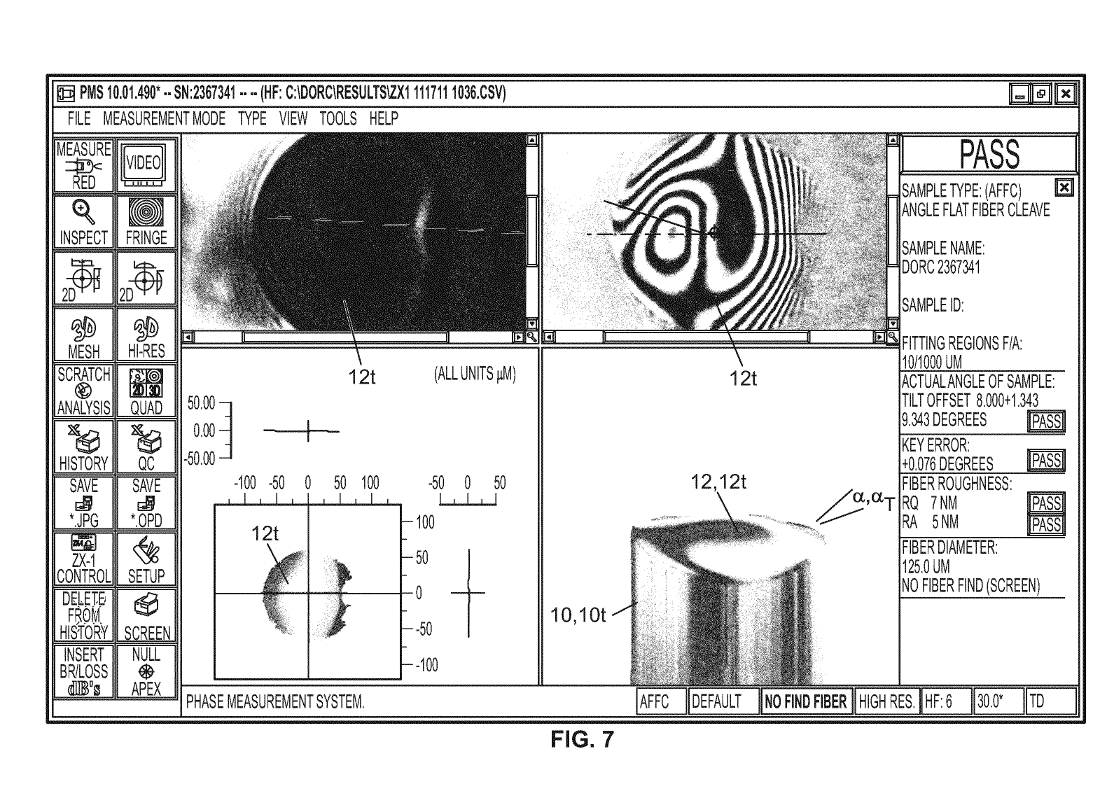

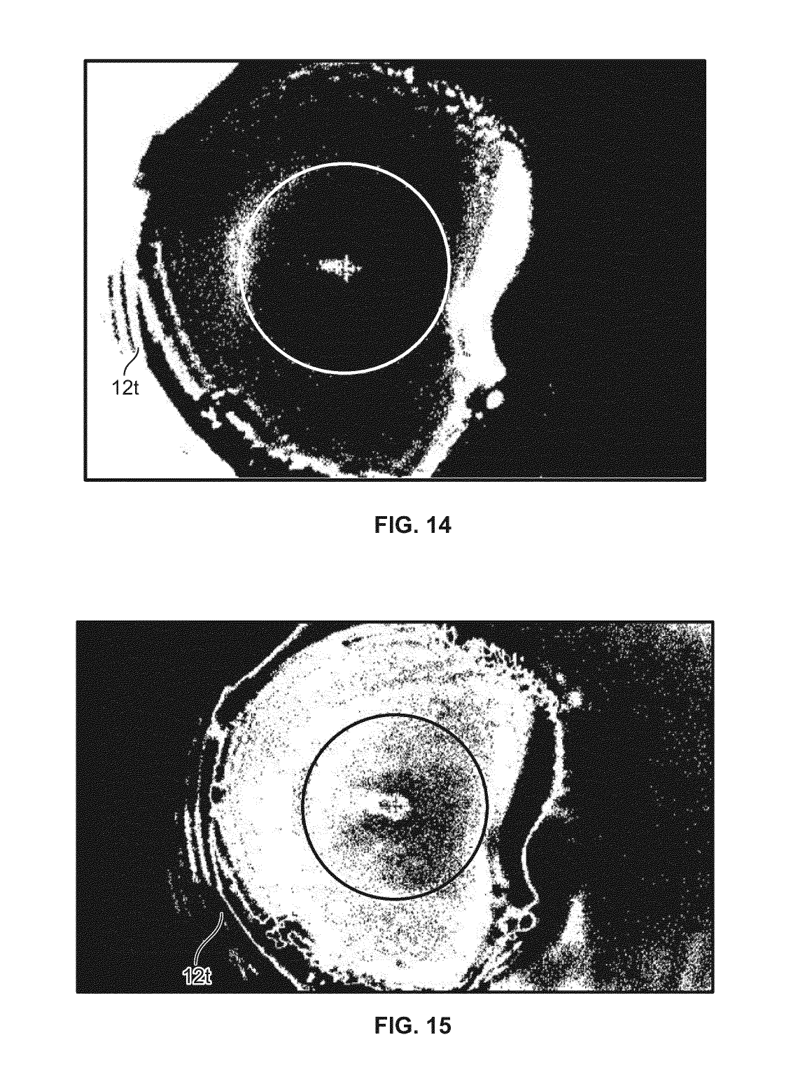

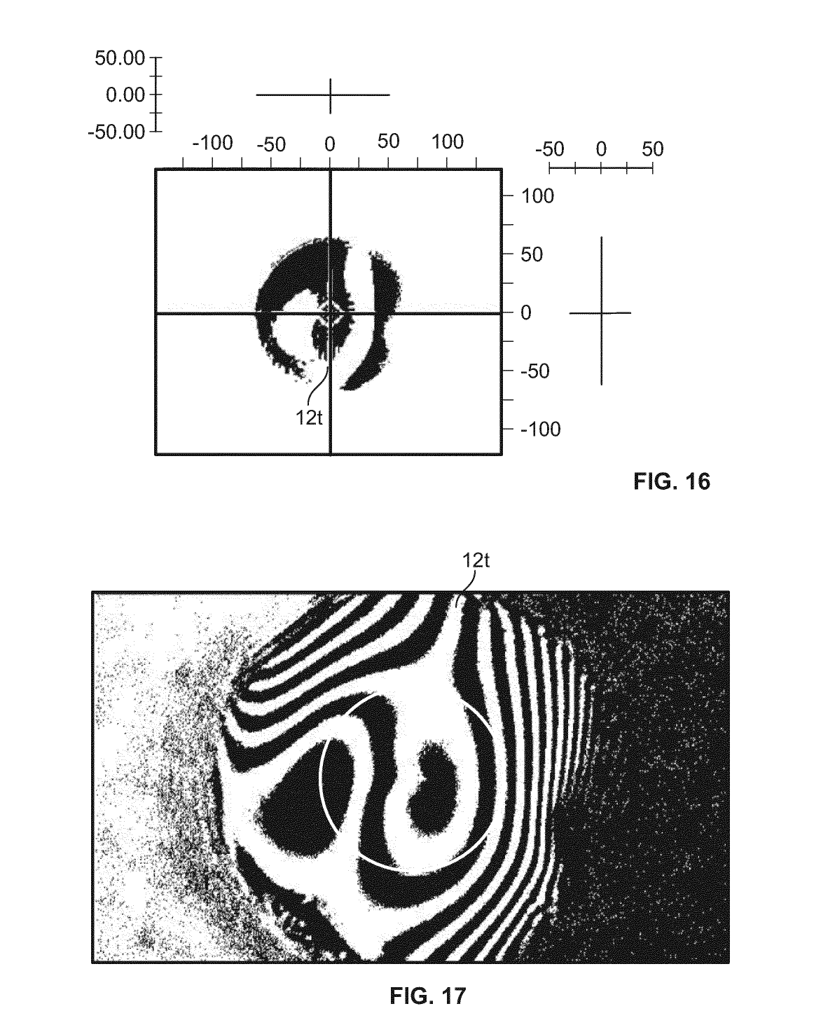

Turning now to FIGS. 7 and 14-17, results of an example measurement of an example cleaved end 12t of an example optical fiber 10t are illustrated. The example optical fiber 10t was cleaved by one of the prior art optical fiber cleaving mechanisms that includes the prior art clamping mechanism 180. The results of the example measurement illustrate defects, imperfections, etc. At least some of the defects, imperfections, etc. result from the torsional stresses placed on the optical fiber 10t by the prior art clamping mechanism 180.

Turning now to FIG. 9, results of an example set of measurements of cleaving angles α_{T} of an example set of cleaved ends 12t of an example set of optical fibers 10t are illustrated. The example set of optical fibers 10t were cleaved by the prior art optical fiber cleaving mechanism that includes the prior art clamping mechanism 180. The results of the example set of measurements illustrate a distribution pattern 300t of cleaving angles α_{T} that vary from a nominal cleaving angle α_{T} of 8 degrees. At least some of the distribution pattern of the cleaving angles α_{T} results from the torsional stresses placed on the optical fibers 10t by the prior art clamping mechanism 180.

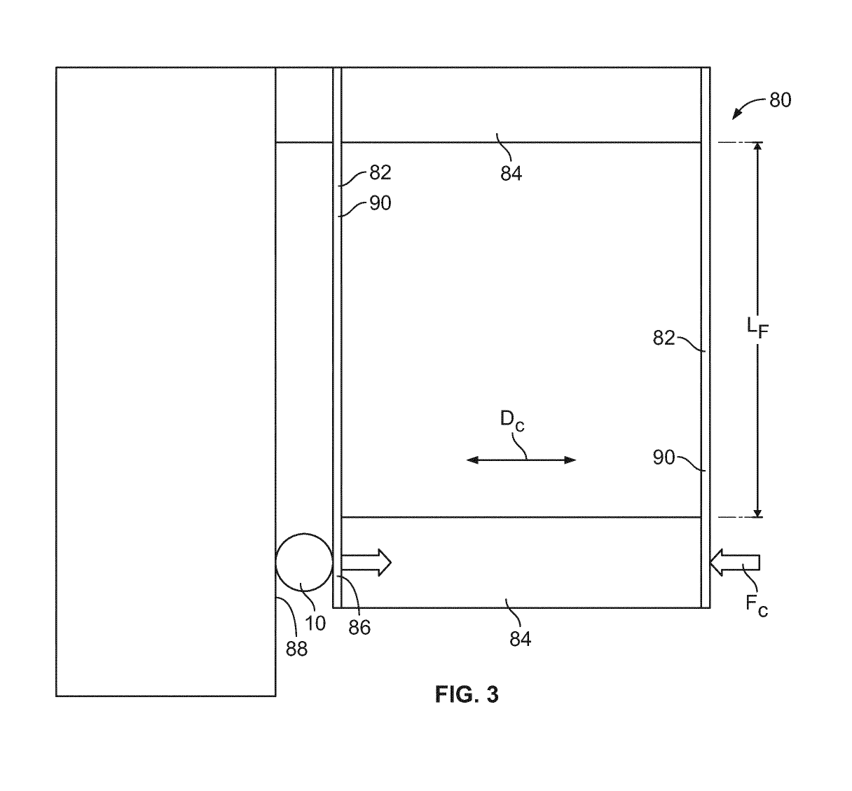

Turning now to FIG. 3, the clamping mechanism 80 will be described in detail. The clamping mechanism 80 includes a set of flexures 82 interconnected by a set of frame elements 84. The flexures 82, in combination with the frame elements 84, provide translational movement to the clamping mechanism 80. In preferred embodiments, the set of flexures 82 is stiff in a first translational direction (e.g., in and out of the page at FIG. 3), a second translational direction (e.g., up and down at FIG. 3), and all rotational directions and is limber in a translational clamping direction D_{C} (e.g., right and left at FIG. 3). In the depicted embodiment, the translational movement of the clamping mechanism 80 corresponds to the translational clamping direction D_{C}. In preferred embodiments, the clamping mechanism 80 does not include any joints with clearance. The clamping mechanism 80 therefore does not undergo a movement similar to the movement M, discussed above, as there are no clearances to shift. A length L_{F} of the flexures 82 can be made sufficiently long and the bending of the flexures 82 can thereby be made sufficiently low that any shortening of the flexures 82 due to bending can be reduced to insignificant magnitudes. In certain embodiments, the length L_{F} of the flexures 82 ranges from about 25 millimeters to about 50 millimeters.

The set of the flexures 82 may include a pair of bending beam elements 90. The set of the frame elements 84 may substantially impose a zero rotation boundary condition on ends of the bending beam elements 90. Bending moments at the ends of the bending beam elements 90 may be balanced by axial tension in one of the bending beam elements 90 and axial compression in another of the bending beam elements 90. The construction of the clamping mechanism 80 can be comparatively low cost as no tight hole clearances, pin diameters, etc. are required. The clamping mechanism 80 can be made of components (e.g., the frame elements 84 and the bending beam elements 90) that self-cancel effects from thermal expansion and/or contraction. Thus, the clamping mechanism 80 can be substantially insensitive to temperature change.

A clamping portion 86 of the clamping mechanism 80 is connected to a clamping surface 88 of the clamping mechanism 80 by the set of the flexures 82. In certain embodiments, the clamping portion 86 and the clamping surface 88 include hard surfaces that engage the optical fiber 10. The set of the flexures 82 substantially allows relative movement between the clamping portion 86 and the clamping surface 88 only in the translational clamping direction D_{C}. The optical fiber 10 can be clamped between the clamping portion 86 and the clamping surface 88 by applying the clamping force F_{C} to the clamping portion 86. The optical fiber 10 can also be clamped between the clamping portion 86 and the clamping surface 88 by applying the clamping force F_{C} to the frame element 84 attached directly to the clamping portion 86.

The set of the flexures 82 substantially prevents any movement of the clamping portion 86 orthogonal to the translational clamping direction D_{C}. Thus, even though the stripped end portion 16s of the optical fiber 10 is very small in diameter (e.g., 125 μm), even very small movements orthogonal to the translational clamping direction D_{C} are substantially prevented and substantial axial twisting of the optical fiber 10 by the clamping mechanism 80 is also prevented.

As depicted at FIG. 3, no clearances result in no looseness of the clamping portion 86 with respect to the clamping surface 88 of the clamping mechanism 80. Even though the optical fiber 10 is cylindrically shaped and provides the rolling surface 11, substantially no movement M results from clamping the clamping mechanism 80. Upon the clamping force F_{C} being generated between the clamping portion 86 and the clamping surface 88, no instability occurs due to the compressive clamping force F_{C} and the rolling surface 11. As illustrated at FIG. 3, equilibrium of the compressive clamping force F_{C} and the rolling surface 11 is inherently achieved and does not include movement M as there are no clearances to close. Furthermore, the clamping portion 86 does not substantially shift, and the rolling surface 11 does not substantially roll. As the rolling surface 11 of the optical fiber 10 does not substantially roll, substantial twisting of the optical fiber 10 is not induced by the clamping portion 86 and the clamping surface 88.

As there is no substantial axial twisting of the optical fiber 10, no substantial torsional stresses are developed along the optical fiber 10, the optical fiber 10 is not substantially rotationally out of the nominal position, and the optical fiber 10 is not substantially translationally out of the nominal position. With substantially no induced torsional stresses present when the optical fiber 10 is cleaved, the cleaved end 12 of the optical fiber 10 may be substantially free of defects, imperfections, etc. that are caused by torsional stresses. In addition, as the torsional stresses do not substantially vary from a first cleaving operation to a second cleaving operation, the cleaved end 12 of the optical fiber 10 does not include substantial variations that are caused by variations in torsional stresses. As the optical fiber 10 is not substantially rotationally out of position when the optical fiber 10 is cleaved, the cleaved end 12 of the optical fiber 10 may be substantially free of defects, imperfections, etc. caused by the optical fiber 10 being rotationally out of position. In addition, as the optical fiber 10 is not substantially rotationally out of position at various positions of various cleaving operations, the cleaved end 12 of the optical fiber 10 does not include substantial variations that are caused by variability of the rotational position of the optical fiber 10. As the optical fiber 10 is not substantially translationally out of position when the optical fiber 10 is cleaved, the cleaved end 12 of the optical fiber 10 does not include substantial defects, imperfections, etc. that are caused by the optical fiber 10 being translationally out of position. In addition, as the optical fiber 10 is not substantially translationally out of position at various positions of various cleaving operations, the cleaved end 12 of the optical fiber 10 does not include substantial variations caused by the variability of the translational position of the optical fiber 10.

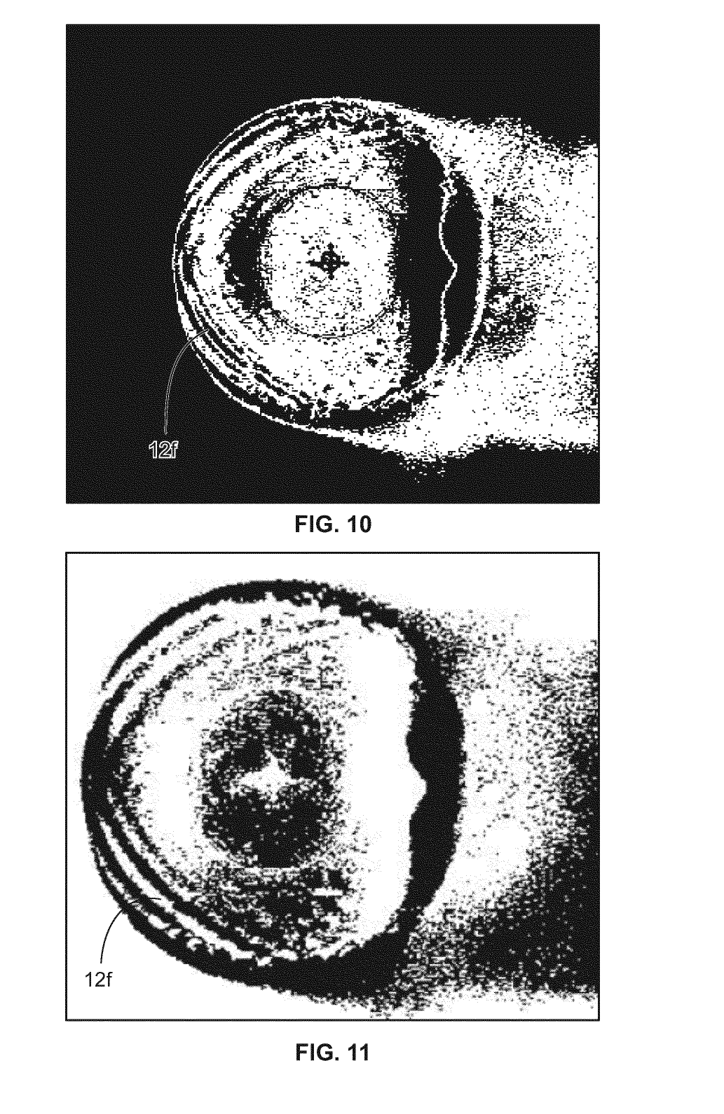

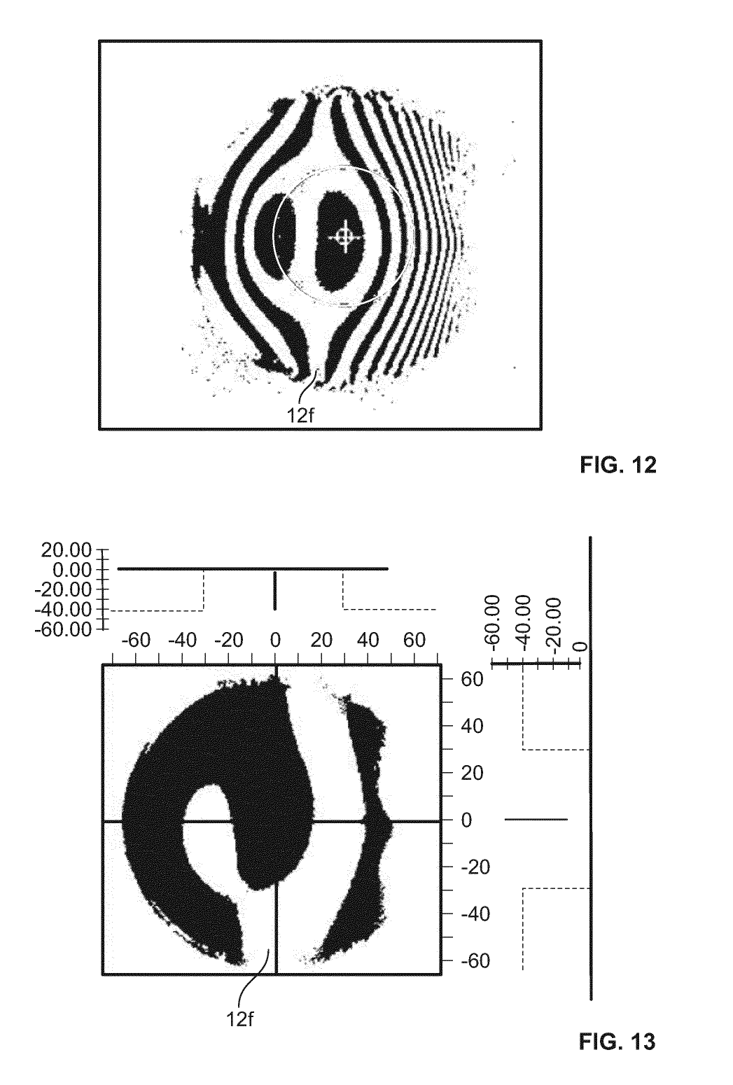

Turning now to FIGS. 6 and 10-13, results of an example measurement of an example cleaved end 12f of an example optical fiber 10f are illustrated. The example optical fiber 10f was cleaved by the optical fiber cleaving mechanism 20 that includes the clamping mechanism 80. The results of the example measurement illustrate a reduction in defects, imperfections, etc. The reduction in defects are thought to occur from the removal of substantial torsional stresses placed on the optical fiber 10f.

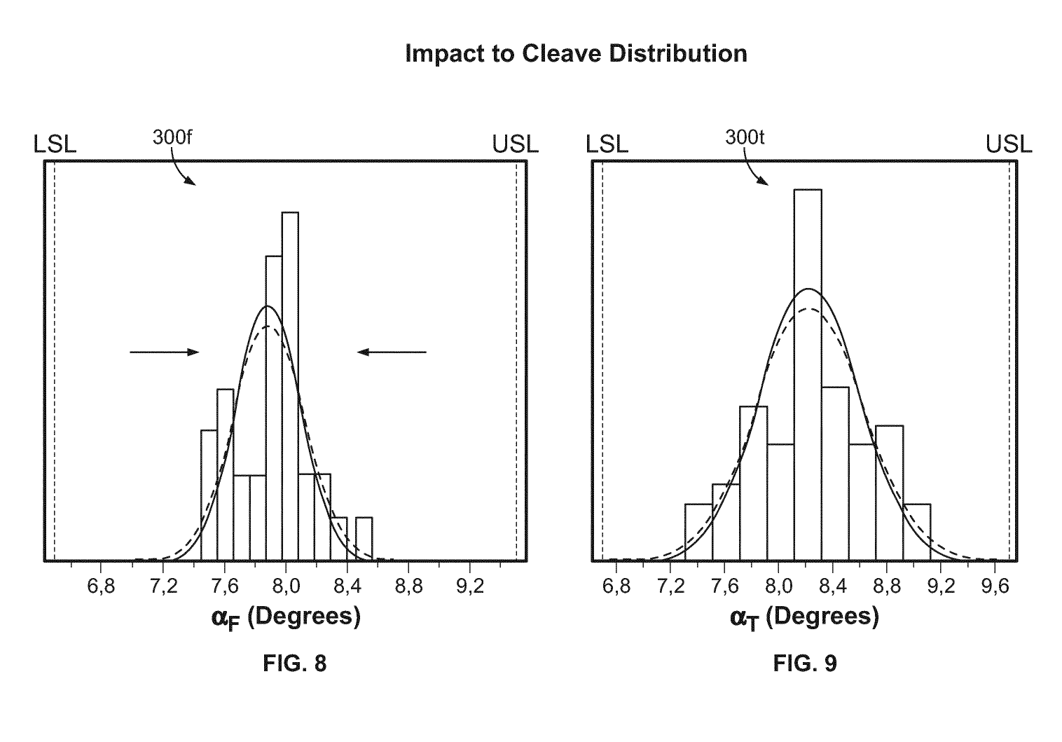

Turning now to FIG. 8, results of an example set of measurements of cleaving angles α_{F} of an example set of cleaved ends 12f of an example set of optical fibers 10f are illustrated. The example set of optical fibers 10f were cleaved by the optical fiber cleaving mechanism 20 that includes the clamping mechanism 80. The results of the example set of measurements illustrate a distribution pattern 300f of cleaving angles α_{F} that vary from a nominal cleaving angle α_{F} of 8 degrees. The distribution pattern 300f is reduced in scatter from the distribution pattern 300t, discussed above. The reduction in scatter of the distribution pattern 300f of the cleaving angles α_{F} is thought to result from the removal of substantial torsional stresses placed on the optical fibers 10f.

Turning now to FIG. 1, the vision system 120 may measure the cleaving angles α_{F} of the cleaved ends 12f. In certain embodiments, a low cost vision system is used as the vision system 120. Effective resolution of the low cost vision system 120 may be enhanced by statistical averaging of the cleaving angles α_{F} of the cleaved ends 12f that are measured.

The tensioner 100 may include a voice coil. Tension produced by the tensioner 100 on the optical fiber 10 may be adjusted to influence the cleaving angles α_{F} of the cleaved ends 12f. The vision system 120 may provide feedback to the tensioner 100 to fine tune the cleaving angles α_{F}. The tuning of the cleaving angles α_{F} by the tensioner 100 may be used to compensate for short term effects (e.g. temperature) and long term effects (e.g., wear). The tensioner 100 may be adapted to detect slippage of the optical fiber 10 with respect to the clamp 80. The cleaving mechanism 20 may stop the cleave tool 60 from cleaving the optical fiber 10 when the tensioner 100 detects the slippage of the optical fiber 10 with respect to the clamp 80. Damage to the cleave tool 60 may be avoided by stopping the cleave tool when slippage has occurred.

Various modifications and alterations of this disclosure will become apparent to those skilled in the art without departing from the scope and spirit of this disclosure, and it should be understood that the scope of this disclosure is not to be unduly limited to the illustrative embodiments set forth herein. The present application incorporates by reference the entire disclosure of U.S. Ser. No. 61/670,855.

### PARTS LIST

α cleaving angle
α_{F} cleaving angles
α_{T} cleaving angles
A axis
D_{C} translational clamping direction
F tensioning force
F_{C} clamping force
L_{C} distance
L_{F} length
M movement
10 optical fiber
10f optical fiber
10t optical fiber
11 rolling surface
12 cleaved end
12f cleaved end
12t cleaved end
14 protective coating
16 end portion
16s stripped end portion
18 fiber optic cable
20 cleaving mechanism
40 fixture
60 cleave tool
80 clamp
82 flexures
84 frame elements
86 clamping portion
88 clamping surface
90 bending beam elements
100 tensioner
120 vision system
180 prior art clamping mechanism
182 joint
184 clearance
186 clamping portion
188 clamping surface
300f distribution pattern
300t distribution pattern

What is claimed is:

1. A cleaving mechanism (20) for cleaving an optical fiber (10) and thereby producing a cleaved end (12) on the optical fiber, the cleaving mechanism comprising:
a fixture (40) for holding the optical fiber;
a cleave tool (60) adapted to cleave the optical fiber; and
a clamp (80) adapted to clamp the optical fiber without substantial twisting of the optical fiber, the clamp positioned opposite the fixture about the cleave tool, wherein the clamp includes a set of flexures (82).

2. The cleaving mechanism of claim 1, wherein the set of flexures is stiff in a first translational direction, a second translational direction, and all rotational directions and is limber in a translational clamping direction (D_{C}).

3. The cleaving mechanism of claims 1 and 2, wherein the set of flexures includes a pair of bending beam elements (90).

4. The cleaving mechanism of claims 1-3, further comprising a tensioner (100) adapted to apply tension on the optical fiber when the optical fiber is held by the fixture and is clamped by the clamp.

5. The cleaving mechanism of claim 4, wherein the tensioner applies a force (F) on the clamp and thereby applies the tension on the optical fiber when the optical fiber is held by the fixture and is clamped by the clamp.

6. The cleaving mechanism of claims 4 and 5, wherein the tensioner includes a voice coil.

7. The cleaving mechanism of claims 4-6, wherein the tensioner is adapted to detect slippage of the optical fiber with respect to the clamp.

8. The cleaving mechanism of claim 7, wherein the cleaving mechanism stops the cleave tool from cleaving the optical fiber when the tensioner detects the slippage of the optical fiber with respect to the clamp.

9. The cleaving mechanism of claims 4-8, wherein the tensioner is adapted to tune an amount of the tension and thereby tune a cleaving angle (a) of the cleaved end.

10. The cleaving mechanism of claim 9, further comprising a vision system (120) adapted to provide feedback and thereby further tune the amount of the tension.

11. The cleaving mechanism of claims 4-9, wherein the tensioner is adapted to compensate for wear of the cleaving mechanism.

12. The cleaving mechanism of claims 1-11, wherein the optical fiber is cleaved at an angle from perpendicular to a longitudinal axis (A) of the optical fiber.

13. The cleaving mechanism of claims 1-12, wherein the optical fiber is cleaved about 8 degrees from perpendicular to the longitudinal axis (A) of the optical fiber.

14. The cleaving mechanism of claims 1-13, further comprising a scoring member adapted to score the optical fiber before the cleaving tool cleaves the optical fiber.

15. The cleaving mechanism of claims 1-14, wherein the cleave tool includes a bending anvil.

16. The cleaving mechanism of claim 15, wherein the bending anvil includes a double anvil structure.

17. The cleaving mechanism of claims 1-16, wherein the fixture includes a fixture clamp adapted to clamp and thereby hold the optical fiber.

18. The cleaving mechanism of claims 1-17, wherein the optical fiber is included in a fiber optic cable (18) and the fiber optic cable further includes a protective layer (14) surrounding the optical fiber and wherein the fixture is adapted to hold the optical fiber by holding the protective layer surrounding the optical fiber.

19. The cleaving mechanism of claims 1-18, wherein any twisting of the optical fiber by the clamp is limited to about 200 degrees per meter.

20. A method for cleaving an optical fiber (10), the method comprising:
providing the optical fiber;
holding the optical fiber with a fixture (40) at a first location of the optical fiber;
clamping the optical fiber with a clamp (80) at a second location of the optical fiber without substantial twisting of the optical fiber between the first and the second locations; and
cleaving the optical fiber between the first and the second locations of the optical fiber with a cleave tool (60).

21. The method of claim 20, wherein a cleaving mechanism (20) includes the fixture, the clamp, and the cleave tool.

22. The method of claims 20 and 21, further comprising tensioning the optical fiber between the first and the second locations of the optical fiber with a tensioner (100).

23. The method of claim 22, further comprising detecting potential slippage of the optical fiber, postponing the cleaving of the optical fiber if any slippage is detected, re-clamping and/or re-holding the optical fiber if any slippage is detected, and resuming the cleaving of the optical fiber if no slippage is detected upon the re-clamping and/or the re-holding the optical fiber.

24. The method of claims 22 and 23, further comprising tuning an amount of the tensioning and thereby tuning a cleaving angle (a) of a cleaved end (12) of the optical fiber.

25. The method of claim 24, further comprising providing feedback with a vision system (120) and thereby further tuning the amount of the tensioning.

26. The method of claims 22-25, further comprising compensating for wear of the cleaving mechanism by adjusting an amount of the tensioning.

27. The method of claims 20-26, further comprising scoring the optical fiber between the first and the second locations of the optical fiber before the cleaving of the optical fiber.

28. The method of claims 20-27, wherein any twisting of the optical fiber by the clamp is limited to about 200 degrees per meter.

29. A method for cleaving an optical fiber (10), the method comprising:
providing the optical fiber;
holding the optical fiber with a fixture (40) at a first location of the optical fiber;
clamping the optical fiber with a clamp (80) at a second location of the optical fiber;
applying a tensile force on the optical fiber between the first and the second locations of the optical fiber with an electromagnetic coil (100); and
cleaving the tensioned optical fiber between the first and the second locations of the optical fiber with a cleave tool (60).

30. The method of claim 29, wherein the electromagnetic coil is a voice coil.

31. The method of claims 29 and 30, further comprising measuring the tensile force applied on the optical fiber by the electromagnetic coil.

32. The method of claim 31, further comprising detecting slippage of the optical fiber at the first location relative to the fixture and/or at the second location relative to the clamp by monitoring the measuring of the tensile force.

33. The method of claim 32, further comprising suspending the cleaving of the optical fiber when the slippage is detected, reclamping and/or reholding the optical fiber, and resuming the cleaving of the optical fiber if no slippage is detected.

34. The method of claims 29-33, further comprising adjusting the tensile force applied on the optical fiber by the electromagnetic coil to a desired tension value.

35. The method of claims 29-34, further comprising measuring an angle (a) of an end face (12) of the optical fiber after cleaving.

36. The method of claim 35, wherein the angle of the end face of the optical fiber after cleaving is measured with a camera (120).

37. The method of claims 35 and 36, further comprising correlating the measured angle and the measured tensile force and determining the desired tension value based on the correlating of the measured angle and the measured tensile force.

38. The method of claim 37, further comprising statistical processing of the correlating of the measured angle and the measured tensile force and subsequently determining the desired tension value based on the correlating of the measured angle and the measured tensile force as refined by the statistical processing.

39. The method of claims 29-38, wherein the clamping of the optical fiber is done without substantial twisting of the optical fiber.

40. The method of claims 29-39, wherein the clamp includes a set of flexures (82).

41. A cleaving mechanism (20) for cleaving an optical fiber (10) and thereby producing a cleaved end (12) on the optical fiber, the cleaving mechanism comprising:
a fixture (40) for holding the optical fiber;
a cleave tool (60) adapted to cleave the optical fiber;
a clamp (80) adapted to clamp the optical fiber, the clamp positioned opposite the fixture about the cleave tool; and
an electromagnetic coil (100) adapted to apply tension to the optical fiber between the fixture and the clamp.

42. The cleaving mechanism of claim 41, wherein the electromagnetic coil is a voice coil.

43. The cleaving mechanism of claims 41 and 42, wherein the electromagnetic coil is adapted to tune an amount of the tension and thereby tune a cleaving angle (a) of the cleaved end.

44. The cleaving mechanism of claims 41-43, further comprising a vision system (120) adapted to provide feedback and thereby tune the amount of the tension.

45. The cleaving mechanism of claims 41-44, wherein the clamp includes a set of flexures (82) and wherein the set of flexures is stiff in a first translational direction, a second translational direction, and all rotational directions and is limber in a translational clamping direction (D_{C}).

46. The cleaving mechanism of claim 45, wherein the set of flexures includes a pair of bending beam elements (90).

47. A method for cleaving an optical fiber (10), the method comprising:
providing the optical fiber;
holding the optical fiber with a fixture (40) at a first location of the optical fiber;
clamping the optical fiber with a clamp (80) at a second location of the optical fiber;
cleaving the optical fiber between the first and the second locations of the optical fiber with a cleave tool (60); and
measuring an angle (a) of an end face (12) of the optical fiber after cleaving.

48. The method of claim 47, wherein the angle of the end face of the optical fiber after cleaving is measured with a camera (120).

49. The method of claims 47 and 48, further comprising correlating the measured angle and a measured parameter of the clamp, the fixture, and/or the cleave tool and determining the measured parameter based on the correlating of the measured angle and the measured parameter.

50. The method of claim 49, further comprising statistical processing of the correlating of the measured angle and the measured parameter and subsequently determining the desired measured parameter based on the correlating of the measured angle and the measured parameter as refined by the statistical processing.

51. A cleaving mechanism (20) for cleaving an optical fiber (10) and thereby producing a cleaved end (12) on the optical fiber, the cleaving mechanism comprising:
a fixture (40) for holding the optical fiber;
a cleave tool (60) adapted to cleave the optical fiber;
a clamp (80) adapted to clamp the optical fiber, the clamp positioned opposite the fixture about the cleave tool; and
a camera (120) adapted to measure an angle (a) of an end face (12) of the optical fiber after cleaving.
